(19) United States
(12) Patent Application Publication
(10) Pub. No.: US 2019/0250860 A1
(43) Pub. Date: Aug. 15, 2019

(54) INTEGRATED CIRCUIT CHIP DEVICE AND RELATED PRODUCT THEREOF

(71) Applicant: Shanghai Cambricon Information Technology Co., Ltd, Shanghai (CN)

(72) Inventors: Yukun TIAN, Shanghai (CN); Zhou FANG, Shanghai (CN); Zidong DU, Shanghai (CN)

(21) Appl. No.: 16/272,963

(22) Filed: Feb. 11, 2019

(30) Foreign Application Priority Data
Feb. 11, 2018 (CN) 201810141373.9

(51) Int. Cl. G06F 3/08; G06F 16/28; G06N 20/00

(52) U.S. Cl. CPC G06F 3/08; G06N 20/00; G06F 16/285

(57) ABSTRACT

The present disclosure provides an integrated circuit chip device and related product thereof. The integrated circuit chip device includes an external interface and a processing circuit. The processing circuit is configured to quantize the first layer input data and the first layer weight group data to obtain a first layer quantized input data and a first layer quantized weight group data; query a first layer output data corresponding to the first layer quantized input data and the first layer quantized weight group data from a preset output result table, determine the first layer output data as a second layer input data, and input the second layer input data into n−1 layers to execute forward operations to obtain n^{th} layer output data; the n^{th} layer output data gradients is determined according to the n^{th} layer output data and the n^{th} layer back operations is obtained according to the training instructions.

### TECHNICAL FIELD

The disclosure relates to a field of neural network and particularly relates to an integrated circuit chip device and related product thereof.

### BACKGROUND

An existing training method of neural network generally adopts back propagation algorithm, and a learning process consists of a forward propagation process and a back propagation process. In the forward propagation process, input data passes through an input layer and hidden layers, and then the data is processed layer by layer and transmitted to an output layer. If expected output data may not be obtained in the output layer, a back propagation process can be performed, and, in the back propagation process, weight gradients of each layer are computed layer by layer; finally, the computed weight gradients are configured to update weight. This is an iteration of neural network training. Those processes need to be repeated a plurality of times in the whole training process until the output data reaches an expected value. In the training process, the training method has problems including excessive amount of parameters and operations as well as low training efficiency.

### SUMMARY

Embodiments of the present disclosure provide an integrated circuit chip device and related product thereof, which may reduce the amount of parameters and operations in training, and reduce data transmission overhead and transmission energy consumption.

In a first aspect, the present disclosure provides an integrated circuit chip device, which is configured to perform neural network training. The neural network includes n layers and n is an integer greater than 1. The device includes an external interface and a processing circuit, wherein,

the external interface is configured to receive training instructions;

the processing circuit is configured to determine a first layer input data, a first layer weight group data and operation instructions included in the first layer according to the training instructions, quantize the first layer input data and the first layer weight group data to obtain a first layer quantized input data and a first layer quantized weight group data; query a first layer output data corresponding to the first layer quantized input data and the first layer quantized weight group data from a preset output result table, determine the first layer output data as a second layer input data, and input the second layer input data into n−1 layers to execute forward operations to obtain nth layer output data;

the processing circuit is further configured to determine nth layer output data gradients according to the nth layer output data, obtain nth layer back operations among the back operations of n layers according to the training instructions, quantize the nth layer output data gradients to obtain nth layer quantized output data gradients, query a nth layer input data gradients corresponding to the nth layer quantized output data gradients and a nth layer quantized input data from the preset output result table, query nth layer weight group gradients corresponding to the nth layer quantized output data gradients and a nth layer quantized weight group data from the preset output result table, and update a weight group data of n layers according to the nth layer weight group gradients;

the processing circuit is further configured to determine the nth input data gradients as n−1th output data gradients, and input the nth input data gradients into n−1 layers to execute back operations to obtain n−1 weight group data gradients, and update n−1 weight group data corresponding to the n−1 weight group data gradients according to the n−1 weight group data gradients, wherein the weight group data of each layer includes at least two weights.

In a second aspect, the present disclosure provides a training method of neural network. The neural network includes n layers and n is an integer greater than 1. The method includes:

receiving training instructions, determining the first layer input data, the first layer weight group data and the operation instructions included in the first layer according to the training instructions, quantizing the first layer input data and the first layer weight group data to obtain the first layer quantized input data and the first layer quantized weight group data; querying the first layer output data corresponding to the first layer quantized input data and the first layer quantized weight group data from the preset output result table, determining the first layer output data as the second layer input data, and inputting the second layer input data into n−1 layers to execute forward operations to obtain the nth layer output data;

determining the nth layer output data gradients according to the nth layer output data, obtaining the nth layer back operations among the back operations of n layers according to the training instructions, quantizing the nth layer output data gradients obtain the nth layer quantized output data gradients, querying the nth layer input data gradients corresponding to the nth layer quantized output data gradients and the nth layer quantized input data from the preset output result table, querying the nth layer weight group gradients corresponding to the nth layer quantized output data gradients and the nth layer quantized weight group data from the preset output result table, and updating the weight group data of n layers according to the nth layer weight group gradients;

inputting the nth input data gradients into the n−1th layer as the n−1th output data gradients to execute back operations to obtain the n−1 weight group data gradients, updating the n−1 weight group data corresponding to the n−1 weight group data gradients according to the n−1 weight group data gradients, wherein the weight group data of each layer includes at least two weights.

In a third aspect, the present disclosure provides a neural network operation device, which includes one or a plurality of integrated circuit chip devices of the first aspect.

In a fourth aspect, the present disclosure provides a combined processing device, which includes: the neural network operation device of the third aspect, a general interconnection interface and a general processing device;

the neural network operation device is connected with the general processing device through the general interconnection interface.

In a fifth aspect, the present disclosure provides a chip, which integrates the device of the first aspect, the device of the third aspect or the device of the fourth aspect.

In a sixth aspect, the present disclosure provides an electronic device, which includes the chip of the fifth aspect.

As may be seen, in embodiments of the present disclosure, on the one hand, the device or method mines the data distribution characteristics by mining similarity among data of each layer of neural network and mining local similarity of data within the layer so as to perform low-bit quantization as well as weight and input data quantization. The low-bit quantization reduces the number of bits representing each data, while the quantization of weight and input data not only reduces the amount of parameters in training but also reduces data transmission overhead and transmission energy consumption. Compared with floating-point number representation, fixed-point number representation and the like, adopting discrete data representation reduces storage energy consumption. On the other hand, possible operations are computed in advance and stored in the output result table, so that computation results may be obtained directly through querying the table in real training, which improves computation efficiency and reduces computation power consumption. By querying the output result table of multi-layer artificial neural network operation, the reusability of input neuron and weight data is fully mined, which avoids repeatedly reading the data to memory, reduces memory access bandwidth and avoids a problem that memory bandwidth becomes a bottleneck of operation performance of multi-layer artificial neural network.

### BRIEF DESCRIPTION OF THE DRAWINGS

FIG. 1 is a structural diagram of an integrated circuit chip device according to an embodiment of the present disclosure.

FIG. 2a is a flow chart of a neural network training method according to an embodiment of the present disclosure.

FIG. 2b is a schematic diagram of a weight grouping according to an embodiment of the present disclosure.

FIG. 2c is a schematic diagram of a clustering weight groups according to an embodiment of the present disclosure.

FIG. 2d is a schematic diagram of an intermediate codebook according to an embodiment of the present disclosure.

FIG. 2e is a schematic diagram of weight group data according to an embodiment of the present disclosure.

FIG. 2f is a schematic diagram of a weight dictionary according to an embodiment of a present disclosure.

FIG. 2g is a schematic diagram of a quantized weight group data according to an embodiment of the present disclosure.

FIG. 3 is a structural diagram of another integrated circuit chip device according to an embodiment of the present disclosure.

FIG. 4 is a structural diagram of a neural network chip device according to an embodiment of the present disclosure.

FIG. 5a is a structural diagram of a combined processing device according to an embodiment of the present disclosure.

FIG. 5b is another structural diagram of a combined processing device according to an embodiment of the present disclosure.

### DETAILED DESCRIPTION OF THE EMBODIMENTS

To facilitate those skilled in the art to understand the present disclosure, technical solutions in the embodiments of the present disclosure will be described clearly and completely hereinafter with reference to the accompanied drawings in the embodiments of the present disclosure. Apparently, the described embodiments are merely some rather than all embodiments of the present disclosure. All other embodiments obtained by those of ordinary skill in the art based on the embodiments of the present disclosure without creative efforts shall fall within the protection scope of the present disclosure.

The terms such as “first”, “second” and the like configured in the specification, the claims, and the accompanied drawings of the present disclosure are configured for distinguishing between different objects rather than describing a particular order. The terms “include” and “comprise” as well as variations thereof are intended to cover non-exclusive inclusion. For example, a process, method, system, product, device, or apparatus including a series of steps or units is not limited to the listed steps or units, it may alternatively include other steps or units that are not listed; alternatively, other steps or units inherent to the process, method, product, or device may be included either.

The term “embodiment” or “implementation” referred to herein means that a particular feature, structure, or characteristic described in conjunction with the embodiment may be contained in at least one embodiment of the present disclosure. The phrase appearing in various places in the specification does not necessarily refer to the same embodiment, nor does it refer to an independent or alternative embodiment that is mutually exclusive with other embodiments. It is expressly and implicitly understood by those skilled in the art that an embodiment described herein may be combined with other embodiments.

In the device provided in the first aspect, for quantizing the first layer weight group data, the processing circuit includes:

a control unit, configured to obtain quantization instructions and decode the quantization instructions to obtain query control information, the query control information including address information corresponding to the first layer weight group data in a preset weight dictionary, the preset weight dictionary including encodings corresponding to all the weights in weight group data of n layers of the neural network;

a dictionary query unit, configured to query K encodings corresponding to K weights in the first layer weight group data from the preset weight dictionary according to the query control information, K being an integer greater than 1;

a codebook query unit, configured to query K quantized weights in the first layer quantized weight group data from the preset codebook according to the K encodings, the preset codebook including Q encodings and Q central weights corresponding to the Q encodings, and Q is an integer greater than 1.

In the device provided in the first aspect, the device further includes a weight dictionary establishment unit, configured to:

determine closest central weights of each weight in weight group data of the n layers of the neural network to the Q central weights in the preset codebook, prior to quantizing the first layer weight group data, and obtain the central weights corresponding to each weight in the weight group data of then layers;

determine encodings of the central weights corresponding to each weight in the weight group data of the n layers according to the preset codebook, obtain the encoding corresponding to each weight in the weight group data of the n layers of the neural network and generate a weight dictionary.

In the device provided in the first aspect, the preset codebook is obtained according to the following steps:

grouping a plurality of weights to obtain a plurality of groups;

clustering weights in each group in the plurality of groups according to a clustering algorithm to obtain a plurality of clusters;

computing a central weight of each cluster in the plurality of clusters;

encoding the central weight of each cluster in the plurality of clusters and generating the codebook.

In the device provided in the first aspect, the clustering algorithm includes any of the following algorithms:

K-means algorithm, K-medoids algorithm, Clara algorithm and Clarans algorithm.

In the device provided in the first aspect, the neural network includes a convolution layers, b full connection layers and c long short-term memory network layers. The step of grouping a plurality of weights to obtain a plurality of groups includes:

grouping weights in each convolution layer of the plurality of weights into a group, weights in each full connection layer of the plurality of weights into a group and weights in each long short-term memory network layer of the plurality of weights into a group to obtain (a+b+c) groups;

the step of clustering weights in each group in the plurality of groups according to a clustering algorithm includes:

clustering weights in each of the (a+b+c) groups according to the K-medoids algorithm.

In the device provided in the first aspect, for quantizing the first layer input data, the processing circuit includes:

a preprocessing unit, configured to preprocess any element value in the first layer input data by using a clip (−zone, zone) operation to obtain the first layer preprocessing data in the preset section [−zone, zone], zone being greater than 0;

a determination unit, configured to determine M values in the preset section [−zone, zone], M being a positive integer, compute absolute values of differences between the first layer preprocessing data and the M values respectively to obtain M absolute values, and determine a minimum absolute value of the M absolute values as the quantized element value corresponding to the element value.

In the method provided in the second aspect, the quantizing the first layer weight group data includes:

obtaining quantization instructions and decoding the quantization instructions to obtain query control information, the query control information including address information corresponding to the first layer weight group data in a preset weight dictionary, the preset weight dictionary including encodings corresponding to all the weights in weight group data of the n layers of the neural network;

querying K encodings corresponding to K weights in the first layer weight group data from the preset weight dictionary according to the query control information, K being an integer greater than 1;

querying K quantized weights in the first layer quantized weight group data from the preset codebook according to the K encodings, the preset codebook including Q encodings and Q central weights corresponding to the Q encodings, and Q is an integer greater than 1.

In the method provided in the second aspect, the preset weight dictionary is obtained according to the following steps:

determining the closest central weights of each weight in weight group data of n layers of the neural network to the Q central weights in the preset codebook, prior to quantizing the first layer weight group data, and obtaining the central weights corresponding to each weight in the weight group data of then layers;

determining encodings of the central weights corresponding to each weight in the weight group data of the n layers according to the preset codebook, obtaining the encoding corresponding to each weight in the weight group data of the n layers of the neural network and generating a weight dictionary.

In the method provided in the second aspect, the preset codebook is obtained according to the following steps:

grouping a plurality of weights to obtain a plurality of groups;

clustering weights in each group in the plurality of groups according to a clustering algorithm to obtain a plurality of clusters;

computing a central weight of each cluster in the plurality of clusters;

encoding the central weight of each cluster in the plurality of clusters and generating the codebook.

In the method provided in the second aspect, the quantizing the first layer input data includes:

preprocessing any element value in the first layer input data by using clip (−zone, zone) operation to obtain the first layer preprocessing data in the preset section [−zone, zone], wherein zone is greater than 0.

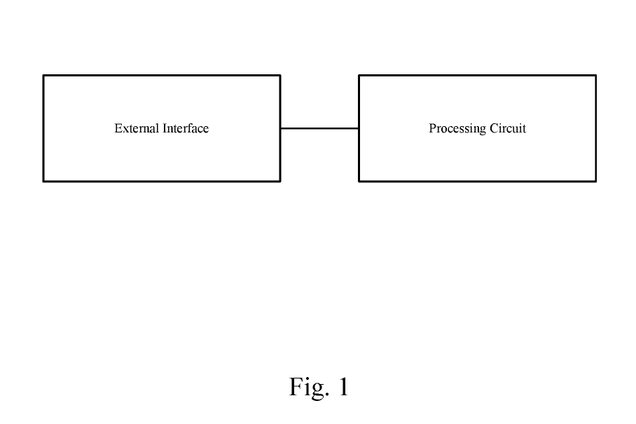

FIG. 1 is a structure diagram of an integrated circuit chip device according to an embodiment of the present disclosure. The integrated circuit chip device is configured to train neural network and the neural network includes n layers, n being an integer greater than 1, wherein the device includes an external interface and a processing circuit, wherein,

the external interface is configured to receive training instructions;

the processing circuit is configured to determine the first layer input data, the first layer weight group data and the operation instructions included in the first layer according to the training instructions, quantize the first layer input data and the first layer weight group data to obtain the first layer quantized input data and the first layer quantized weight group data; query the first layer output data corresponding to the first layer quantized input data and the first layer quantized weight group data from the preset output result table, determine the first layer output data as the second layer input data, and input the second input data into the n−1 layers to execute forward operations to obtain the nth layer output data;

the processing circuit is further configured to determine the nth layer output data gradients according to the nth layer output data, obtain the nth layer back operations among the back operations of the n layers according to the training instructions, quantize the nth layer output data gradients to obtain the nth layer quantized output data gradients, query the nth layer input data gradients corresponding to the nth layer quantized output data gradients and the nth layer quantized input data from the preset output result table, query the nth layer weight group gradients corresponding to the nth layer quantized output data gradients and the nth layer quantized weight group data from the preset output result table, and update the weight group data of n layers according to the nth layer weight group gradients;

the processing circuit is further configured to determine the nth input data gradients as the n−1th output data gradients, and input the n−1th output data gradients into the n−1 layers to execute back operations to obtain the n−1 weight group data gradients and update the n−1 weight group data corresponding to the n−1 weight group data gradients according to the n−1 weight group data gradients, wherein the weight group data of each layer includes at least two weights.

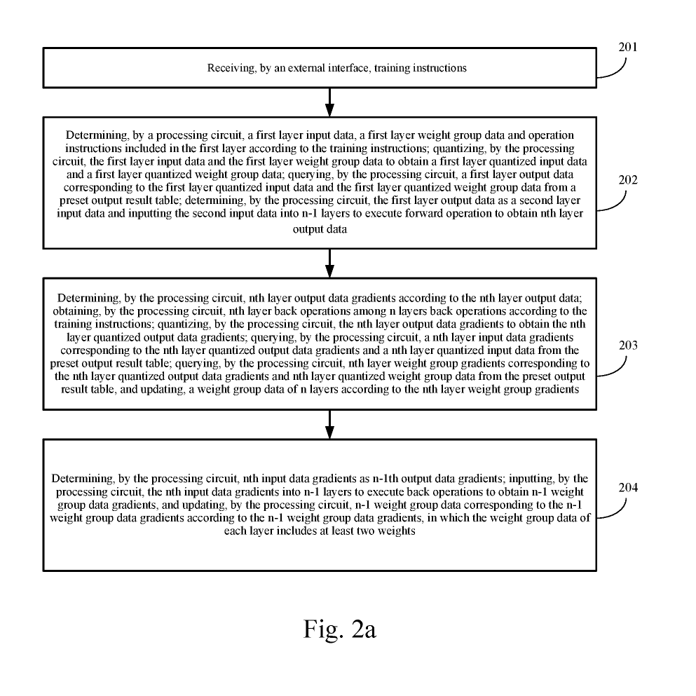

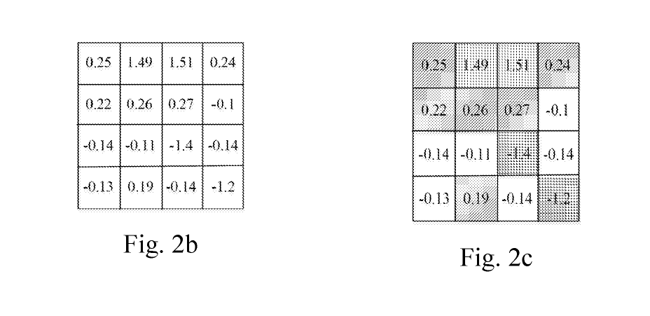

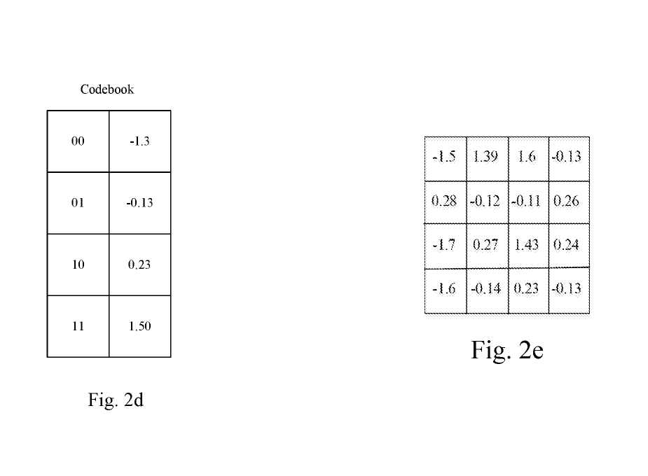

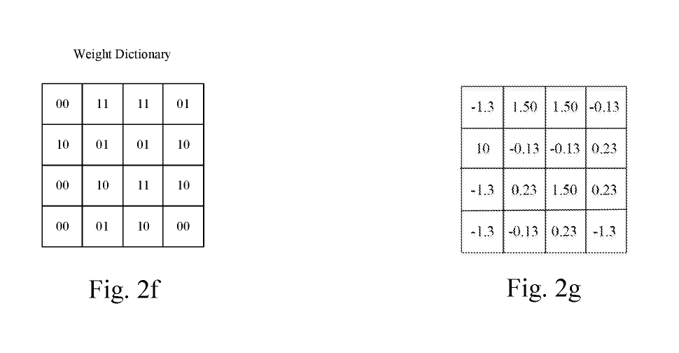

As shown in FIG. 2a, FIG. 2a is a flow chart of a neural network training method according to an embodiment of the present disclosure. The neural network training method described in the present embodiment is configured to train neural network. The neural network includes n layers and n is an integer greater than 1. The method includes:

201. The external interface receives training instructions,

wherein the training instructions are neural network specific instructions, including all specific instructions for completing artificial neural network operation. The neural network specific instructions include but are not limited to control instructions, data transmission instructions, operation instructions and logical instructions, wherein control instructions are configured to control the execution process of neural network; data transmission instructions are configured to complete data transmission between different storage media; data formats include but are not limited to matrices, vectors and scalars. Operation instructions are configured to complete arithmetic operations of neural network, including but not limited to matrix operation instructions, vector operation instructions, scalar operation instructions, convolution neural network operation instructions, fully connected neural network operation instructions, pooling neural network operation instructions, RBM neural network operation instructions, LRN neural network operation instructions, LCN neural network operation instructions and LSTM neural network operation instructions, RNN neural network operation instructions, RELU neural network operation instructions, PRELU neural network operation instructions, SIGMOID neural network operation instructions, TANH neural network operation instructions and MAXOUT neural network operation instructions. Logical instructions are configured to complete neural network logical operations, including but not limited to vector logical operation instructions and scalar logical operation instructions.

Wherein, RBM neural network operation instructions are configured to implement Restricted Boltzmann Machine (RBM) neural network operation;

LRN neural network operation instructions are configured to implement Local Response Normalization (LRN) neural network operation;

LSTM neural network operation instructions are configured to implement Long Short-Term Memory (LSTM) neural network operation;

RNN neural network operation instructions are configured to implement the neural network operation of Recurrent Neural Networks;

RELU neural network operation instructions are configured to implement Rectified Linear Unit (RELU, RNN) neural network operation;

PRELU neural network operation instructions are configured to implement Parametric Rectified Linear Unit (PRELU) neural network operation;

SIGMOID neural network operation instructions are configured to implement SIGMOID neural network operation;

TANH neural network operation instructions are configured to implement TANH neural network operation;

MAXOUT neural network operation instructions are configured to implement MAXOUT neural network operation.

Furthermore, the neural network specific instructions include Cambricon instruction set.

The Cambricon instruction set includes at least one Cambricon instruction, and the length of the Cambricon instruction is 64 bits. The Cambricon instruction consists of operation codes and operands and contains four types of instructions, which are Cambricon control instructions, Cambricon data transfer instructions, Cambricon operation instructions and Cambricon logical instructions.

Wherein, the Cambricon control instructions are configured to control execution process, and include jump instructions and conditional branch instructions.

The Cambricon data transfer instructions are configured to complete data transmission between different storage media and include load instructions, store instructions and move instructions. The load instructions are configured to load data from primary memory to cache, and the store instructions are configured to store data from cache to primary memory, and the move instructions are configured to move data between cache and cache or between cache and register or between register and register. The data transmission instructions support three different ways of data organization, including matrices, vectors and scalars.

The Cambricon operation instructions are configured to complete arithmetic operation of neural network, and include Cambricon matrix operation instructions, Cambricon vector operation instructions and Cambricon scalar operation instructions.

The Cambricon matrix operation instructions are configured to complete matrix operations in neural network, including matrix multiply vector operations, vector multiply matrix operations, matrix multiply scalar operations, outer product operations, matrix add matrix operations and matrix subtract matrix operations.

The Cambricon vector operation instructions are configured to complete vector operations in neural network, including vector elementary arithmetic operations, vector transcendental function operations, dot product operations, random vector generator operations and maximum/minimum of a vector operation, wherein the vector elementary arithmetic operations include vector addition operations, subtraction operations, multiplication operations and division operations. The vector transcendental functions refer to the functions that do not satisfy any polynomial equation with polynomial coefficients, including but not limited to exponential functions, logarithmic functions, trigonometric functions and inverse trigonometric functions.

The Cambricon scalar operation instructions are configured to complete scalar operations in neural networks, including scalar elementary arithmetic operations and scalar transcendental function operations, wherein the scalar elementary arithmetic operations include scalar addition subtraction operations, multiplication operations and division operations. The scalar transcendental functions refer to the functions that do not satisfy any polynomial equation with polynomial coefficients, including but not limited to exponential functions, logarithmic functions, trigonometric functions and inverse trigonometric functions.

The Cambricon logical instructions are configured to complete logical operations of neural networks, including Cambricon vector logical operation instructions and Cambricon scalar logical operation instructions.

The Cambricon vector logical operation instructions include vector comparison operations, vector logical operations and vector greater than merge operations, wherein vector comparison operations include but are not limited to “greater than”, “less than”, “equal to”, “greater than or equal to”, “less than or equal to” and “not equal to”. The vector logical operations include “and”, “or” and “not”.

The Cambricon scalar logical operation instructions include scalar compare and scalar logical operations, wherein the scalar comparison operations include but are not limited to “greater than”, “less than”, “equal to”, “greater than or equal to”, “less than or equal to” and “not equal to”. The scalar logical operations include “and”, “or” and “not”.

202. The processing circuit is configured to determine the first layer input data, the first layer weight group data and the operation instructions included in the first layer according to the training instructions, quantize the first layer input data and the first layer weight group data to obtain the first layer quantized input data and the first layer quantized weight group data; query the first layer output data corresponding to the first layer quantized input data and the first layer quantized weight group data from the preset output result table, and determine the first layer output data as the second layer input data, and input the second layer input data into the n−1 layers to execute forward operations to obtain the nth layer output data,

In an alternative embodiment, quantizing the first layer weight group data may include the following steps:

obtaining quantization instructions and decoding the quantization instructions to obtain query control information, the query control information including address information corresponding to the first layer weight group data in a preset weight dictionary and the preset weight dictionary including encodings corresponding to all the weights in weight group data of n layers of the neural network;

querying K encodings corresponding to K weights in the first layer weight group data from the preset weight dictionary according to the query control information, wherein K is an integer greater than 1;

querying K quantized weights in the first layer quantized weight group data from the preset codebook according to the K encodings, the preset codebook including Q encodings and Q central weights corresponding to the Q encodings, and Q is an integer greater than 1.

In an alternative embodiment, the preset weight dictionary is obtained according to the following steps:

determining the closest central weights of each weight in the weight group data of the n layers of the neural network to the Q central weights in the preset codebook, and obtaining the central weights corresponding to each weight in the weight group data of the n layers;

determining encodings of the central weights corresponding to each weight in the weight group data of n layers according to the preset codebook, obtaining the encoding corresponding to each weight in the weight group data of n layers of the neural network and generating a weight dictionary.

Wherein, the above central weights corresponding to each weight in the weight group data of n layers may be configured to replace values of all the weights in a cluster. Specifically, when establishing the preset codebook, all the weights of any cluster are computed according to the following cost function:

$$J ( w , {w}_{0} ) = {\sum }_{1}^{m} {( {w}_{i} - {w}_{0} )}^{2}$$

Wherein, w refers to all the weights in a cluster; w0 refers to the central weight in the cluster; m refers to the number of weights in the cluster; and wi refers to the ith weight in the cluster, i being a positive integer greater than or equal to 1 and less than or equal to m.

Wherein, the method of determining the closest central weights of each weight in the weight group data of n layers of the neural network to the Q central weights in the preset codebook may be achieved by the following steps. Absolute values of differences between each weight and each of the Q central weights may be computed to obtain Q absolute values, wherein a central weight corresponding to a minimum absolute value of the Q central weights is the closest central weight of the weight to the Q central weights in the preset codebook.

In an alternative embodiment, the preset codebook is obtained according to the following steps:

grouping a plurality of weights to obtain a plurality of groups;

clustering weights in each group in the plurality of groups according to a clustering algorithm to obtain a plurality of clusters;

computing a central weight of each cluster in the plurality of clusters;

encoding the central weight of each cluster in the plurality of clusters and generating the codebook.

In an embodiment of the present disclosure, a plurality of weights may be grouped and then each group may be clustered to establish a codebook. The weights may be grouped in any of the following ways: putting into a group, layer-type grouping, inter-layer grouping, intra-layer grouping, mixed grouping, etc.

In an alternative embodiment, the plurality of weights are put into a group and all the weights in the group are clustered by K-means algorithm.

In an alternative embodiment, the plurality of weights are grouped according to layer types. Specifically, assuming that the neural network consists of a convolution layers, b full connection layers and c long and short-term memory network layers (LSTM), a, b and c being integers, weights in each convolution layer may be put into a group, and weights in each full connection layer may be put into a group, and weights of each LSTM layer may be put into a group. In this way, the plurality of weights are put into (a+b+c) groups and the weights in each group are clustered by K-medoids algorithm.

In an alternative embodiment, the plurality of weights are grouped according to inter-layer structure. Specifically, one or a plurality of subsequent convolution layers are put into one group, one or a plurality of subsequent full connection layers are put into one group; and one or a plurality of subsequent LSTM layers are put into one group. Then the weights in each group are clustered by Clara algorithm.

In an alternative embodiment, the plurality of weights are grouped according to intra-layer structure. The convolution layer of neural network may be regarded as a four-dimensional matrix (Nfin, Nfout, Kx, Ky), wherein Nfin, Nfout, Kx and Ky are positive integers. Nfin represents the number of input feature maps. Nfout represents the number of output feature maps. (Kx, Ky) represents the size of convolution kernels. Weights of the convolution layer are put into Nfin*Nfout*Kx*Ky/(Bfin*Bfout*Bx*By) different groups according to the group size of (Bfin, Bfout, Bx, By), wherein Bfin is a positive integer less than or equal to Nfin, and Bfout is a positive integer less than or equal to Nfout, and Bx is a positive integer less than or equal to Kx, and By is a positive integer less than or equal to Ky. The full connection layer of neural network may be regarded as a two-dimensional matrix (Nin, Nout), wherein Nin and Nout are positive integers. Nin represents the number of input neurons and Nout represents the number of output neurons. The number of weights is Nin*Nout. According to the group size of (Bin, Bout), weights of the full connection layer are put into (Nin*Nout)/(Bin*Bout) different groups, wherein Bin is a positive integer less than or equal to Nin and Bout is a positive integer less than or equal to Nout. Weights in the LSTM layer of neural network may be regarded as a plurality of combinations of weights in the full connection layer, and assuming that the weights in the LSTM layer consist of s weights in the full connection layer, s being a positive integer, each full connection layer may be grouped according to the grouping method of the full connection layer and weights in each group may be clustered by Clarans clustering algorithm.

In an alternative embodiment, the plurality of weights are grouped in a mixed manner. For example, all the convolution layers are put into a group; all the full connection layers are grouped according to the intra-layer structure; all the LSTM layers are grouped according to the inter-layer structure; and weights in each group may be clustered by Clarans clustering algorithm.

An example of the process of establishing the preset codebook is shown as follows.

Firstly, a plurality of weights are grouped in a mixed manner to obtain a plurality of groups. FIG. 2b is a schematic diagram of a weight grouping according to an embodiment of the present disclosure. As shown in FIG. 2b, the grouped weights are clustered and then the similar weights are put into one cluster, thus the four clusters shown in FIG. 2c are obtained, wherein the weights in each cluster are marked by the same cluster identifier, and each of the four clusters are computed according to the cost function to obtain four central weights of 1.50, −0.13, −1.3 and 0.23. Each cluster corresponds to a central weight and then the four central weights are encoded. As shown in FIG. 2d, the cluster with the central weight being −1.3 is encoded to 00; the cluster with the central weight being −0.13 is encoded to 01; the cluster with the central weight being 0.23 is encoded to 10; and the cluster with the central weight being 1.50 is encoded to 11. The codebook shown in FIG. 2d is generated according to the four central weights and the encodings corresponding to each central weight.

An example of an establishing process of the weight dictionary is shown as follows.

Prior to quantizing the first layer weight group data, for the weight group data of n layers of neural network shown in FIG. 2e, absolute values of differences between each weight and each central weight in the preset codebook shown in FIG. 2d are computed. In the weight group data shown in FIG. 2e, when the weight is −1.5, the difference between the weight and the four central weights of 1.50, −0.13, −1.3 and 0.23 are computed respectively. It can be obtained that the central weight corresponding to the minimum absolute value is −1.3, and the encoding in the codebook corresponding to the central weight (−1,3) in the codebook is 00. Similarly, the central weights corresponding to other weights may be obtained. The weight dictionary shown in FIG. 2f is generated according to the encodings of each weight in the weight group data and the encodings corresponding to the weight group data can be obtained by querying from the preset codebook as shown in FIG. 2d.

An example of the process of querying the first layer quantized weight group data corresponding to the first layer weight group data according to the weight dictionary and the preset codebook is shown as follows.

According to the weight dictionary shown in FIG. 2f, the central weight corresponding to each encoding in the weight dictionary is queried from the preset codebook shown in FIG. 2d. As shown in FIG. 2f and FIG. 2d, the central weight corresponding to the encoding 00 is −1.3, and the central weight is a quantized weight corresponding to the encoding 00. Similarly, quantized weights corresponding to other encodings may be obtained, as shown in FIG. 2g.

In an alternative embodiment, quantizing the first layer input data may include the following steps:

preprocessing any element value in the first layer input data by using clip (−zone, zone) operation to obtain the first layer preprocessing data in the preset section [−zone, zone], zone being greater than 0;

determining M values in the preset section [−zone, zone], wherein M is a positive integer, computing absolute values of differences between the first layer preprocessing data and the M values respectively to obtain M absolute values, and determining the minimum absolute value of the M absolute values as the quantized element value corresponding to the element value.

Wherein, the preset section [−zone, zone] may be, for example, [4,1] or [−2,2].

In an alternative embodiment, M values may be preset M values.

In an alternative embodiment, M values may be randomly generated by the system.

In an alternative embodiment, M values may be generated according to certain rules. For example, an absolute value of each value in the M values may be set to be a reciprocal of a power of 2.

In an alternative embodiment, the preprocessing operations may include at least one of the following: segmentation operations, Gauss filtering operations, binarization operations, regularization operations and normalization operations.

For example, assuming that the size of any element value of the first layer input data is quantized to 3 bits, then the value of M is not greater than 23=8. M may be set as 7 and the 7 values may be, for example, {−1, −0.67, −0.33, 0, 0.33, 0.67, 1}. If preprocessed data of an element value is 0.4, the minimum absolute value of the difference between the element value and the preprocessed data may be determined to be 0.33, then the quantized input data is 0.33.

203. The processing circuit determines the nth layer output data gradients according to the nth layer output data, obtains the nth layer back operations among the n layers back operations according to the training instructions, quantizes the nth layer output data gradients to obtain the nth layer quantized output data gradients, queries the nth layer input data gradients corresponding to the nth layer quantized output data gradients and the nth layer quantized input data from the preset output result table, queries the nth layer weight group gradients corresponding to the nth layer quantized output data gradients and the nth layer quantized weight group data from the preset output result table, and updates the weight group data of n layers according to the nth layer weight group gradients.

204. The processing circuit determines the nth input data gradients as the n−1th output data gradients and inputs the n−1th output data gradients into the n−1 layers to execute back operations to obtain the n−1 weight group data gradients, updates the n−1 weight group data corresponding to the n−1 weight group data gradients according to the n−1 weight group data gradients. The weight group data of each layer includes at least two weights.

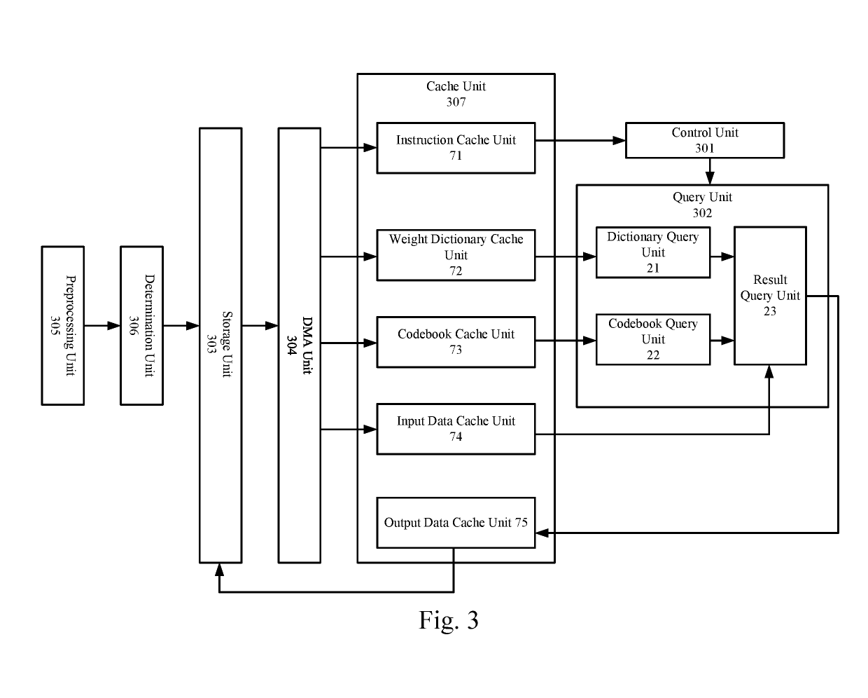

FIG. 3 is a schematic diagram of another integrated circuit chip device according to an embodiment of the present disclosure. The integrated circuit chip device includes a control unit 301, a query unit 302, a storage unit 303, a DMA unit 304, a preprocessing unit 305, a determination unit 306 and a cache unit 307, wherein,

the control unit 301 is configured to obtain quantization instructions and decode the quantization instruction to obtain the query control information, the query control information including the address information corresponding to the first layer weight group data in the preset weight dictionary, and the preset weight dictionary contains the encodings corresponding to all the weights in the weight group data of n layers of the neural network;

the query unit 302 includes a dictionary query unit 21, a codebook query unit 22 and a result query unit 23, wherein the dictionary query unit 21 is configured to query K encodings corresponding to K weights in the first layer weight group data from the preset weight dictionary according to the query control information, K being an integer greater than 1; the codebook query unit 22 is configured to query K quantized weights in the first layer quantized weight group data from the preset codebook according to the K encodings, the preset codebook including Q encodings and Q central weights corresponding to the Q encodings, Q being an integer greater than 1; the result query unit 23 is configured to query the output data corresponding to the quantized input data and the quantized weight group data from the preset output result table.

The storage unit 303 is configured to store external input data, weight dictionary, codebook and training instructions, and also store unquantized weight group data.

The direct memory access (DMA) unit 204 is configured to directly read input data, weight dictionary, codebook and instructions from the storage unit 203, and output the input data, the weight dictionary, the codebook and the training instructions to the cache unit 207.

The preprocessing unit 305 is configured to preprocess the first layer input data by using a clip (−zone, zone) operation to obtain the first layer preprocessing data within the preset section [−zone, zone], zone being greater than 0. The preprocessing operations include segmentation operations, Gauss filtering operations, binarization operations, regularization operations, normalization operations and the like.

The determination unit 306 is configured to determine M values in the preset section [−zone, zone], M being a positive integer, compute absolute values of differences between the first layer preprocessing data and the M values respectively to obtain M absolute values, and determine the minimum absolute value of the M absolute values as the quantized element value corresponding to the element value.

The cache unit 307 includes an instruction cache unit 71, a weight dictionary cache unit 72, a codebook cache unit 73, an input data cache unit 74 and an output data cache unit 75, wherein the instruction cache unit 71 is configured to cache training instructions; the weight dictionary cache unit 72 is configured to cache the weight dictionary; the codebook cache unit 73 is configured to cache the codebook; the input data cache unit 74 is configured to cache the input data; and the output data cache unit 75 is configured to cache the output data.

The external input data is preprocessed by the preprocessing unit 305 to obtain the preprocessed data and the quantized input data is determined by the determination unit 306. The DMA unit 304 directly reads the quantized input data, the weight dictionary, the codebook and cashes the training instructions from the storage unit 303, and then outputs and cashes the training instructions to the instruction cache unit 71, outputs and cashes the weight dictionary to the weight dictionary cache unit 72, outputs and cashes the codebook to the codebook cache unit 73, and outputs and cashes the input neuron to the input neuron cache unit 74. The control unit 301 decodes the received instructions, obtains and outputs query control information and operation control information. The dictionary query unit 21 and the codebook query unit 22 perform query operation on the weight dictionary and the codebook according to the received query control information to obtain quantized weight, and then output the quantized weight to the result query unit 23. The result query unit 23 determines operations and operation sequence according to the received operation control information, queries the output data corresponding to the quantized input data and the quantized weight from the result query table, outputs the output data to the output data cache unit 75, and finally the output data cache unit 75 outputs the output data to the storage unit 303 for storage.

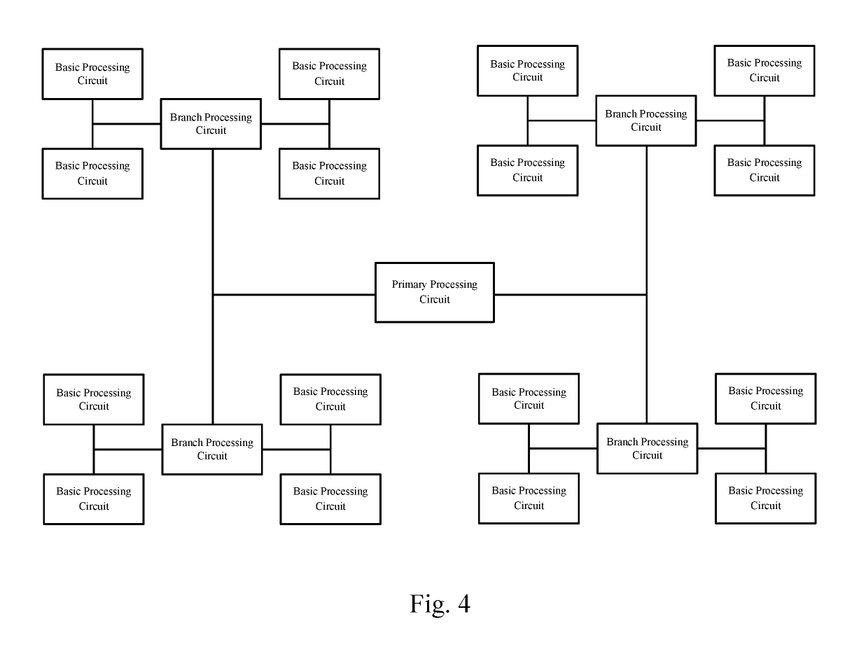

Referring to FIG. 4, FIG. 4 is a schematic diagram of a neural network chip device according to an embodiment of the present disclosure. The chip includes a primary processing circuit, a basic processing circuit and (alternatively) a branch processing circuit.

The primary processing circuit may include a register and/or on-chip cache circuit, and may include a control circuit, a query circuit, an input data quantization circuit, a weight group data quantization circuit and a cache circuit, wherein the query circuit includes a dictionary query unit, a codebook query unit and a result query unit. The result query unit is configured to query the output data corresponding to the quantized weight group data and the quantized input data from the preset output result table, query the input data gradients corresponding to the quantized output data gradients and the quantized input data from the preset output result table and query the weight group gradients corresponding to the quantized output data gradients and the quantized weight group data from the preset output result table. Specifically, in the n-layer neural network, corresponding vector operation output results are queried according to operation control instructions. For example, the vector operation output results are queried according to the vector operation instructions; corresponding logical operation output results are queried according to logical operation instructions; and corresponding accumulation operation output results are queried according to accumulation operation instructions.

In an alternative embodiment, the weight group data quantization circuit is specifically configured to obtain quantization instructions and decode the quantization instructions to obtain query control information, query K encodings corresponding to K weights in the first layer weight group data from the preset weight dictionary according to the query control information, and query K quantized weights in the first layer quantized weight group data from the preset codebook according to the K encodings.

In an alternative embodiment, the input data quantization circuit is configured to preprocess any element value in the input data of each layer by using clip (−zone, zone) operation to obtain the preprocessed data in the preset interval [−zone, zone], determine M values in the preset section [−zone, zone], wherein M is a positive integer, compute absolute values of differences between the first layer preprocessing data and the M values respectively to obtain M absolute values, and determine the minimum absolute value of the M absolute values as the quantized element value corresponding to the element value to quantize the input data.

In an alternative embodiment, in the process of querying results according to operation instructions by the query unit of the primary processing circuit, the query unit of the primary processing circuit is further configured to determine the output results queried by the forward-level operation control instructions as intermediate results, and then queries output results of next-level operation instructions according to the intermediate results.

In an alternative embodiment, the primary processing circuit may further include an operation circuit. Specifically, the output results queried by the forward-level operation control instruction may be configured as intermediate result, and then the operation circuit executes operations of next-level operation control instructions according to the intermediate result.

In an alternative embodiment, the operation circuit may include a vector operational circuit, an inner product operation circuit, an accumulation operation circuit or a logical operation circuit etc.

In an alternative embodiment, the primary processing circuit also includes a data transmission circuit, a data receiving circuit or interface, wherein a data distribution circuit and a data broadcasting circuit may be integrated in the data transmission circuit. In practical applications, the data distribution circuit and the data broadcasting circuit may be arranged separately; the data transmission circuit and the data receiving circuit may also be integrated to form a data transceiving circuit. Broadcast data refers to the data that needs to be transmitted to each basic processing circuit and distribution data refers to the data that needs to be selectively transmitted to part of basic processing circuits. The specific selection method may be determined by the primary processing circuit according to the loads and computation method. The method of broadcasting transmission refers to transmitting the broadcast data to each basic processing circuit in the form of broadcasting. (In practical applications, the broadcast data may be transmitted to each basic processing circuit by one broadcast or a plurality of broadcasts. The number of the broadcasts is not limited in the specific implementation of the disclosure). The method of distribution transmission refers to selectively transmitting the distribution data to part of basic processing circuits.

The control circuit of the primary processing circuit transmits data to part or all of the basic processing circuits when distributing data (wherein the data may be identical or different). Specifically, if data are transmitted by means of distribution, the data received by each basic processing circuit may be different, alternatively, part of the basic processing circuits may receive the same data.

Specifically, when broadcasting data, the control circuit of the primary processing circuit transmits data to part or all of basic processing circuits, and each basic processing circuit may receive the same data.

Each basic processing circuit may include a basic register and/or a basic on-chip cache circuit; alternatively, each basic processing circuit may further include a control circuit, a query circuit, an input data quantization circuit, a weight group data quantization circuit and a cache circuit.

In an alternative embodiment, the chip device may also include one or more branch processing circuits. If a branch processing circuit is included, the primary processing circuit is connected with the branch processing circuit and the branch processing circuit is connected with the basic processing circuit. The inner product operation result query circuit of the basic processing circuit is configured to query output results of the inner product operation from the preset result table. The control circuit of the primary processing circuit controls the data receiving circuit or the data transmission circuit to transceive external data, and controls the data transmission circuit to distribute external data to the branch processing circuit. The branch processing circuit is configured to transceive data from the primary processing circuit or the basic processing circuit. The structure shown in FIG. 4 is suitable for complex data computation because the number of units connected with the primary processing circuit is limited, so a branch processing circuit needs to be added between the primary processing circuit and the basic processing circuit to access more basic processing circuit, so as to realize computation of complex data blocks. The connection structure of the branch processing circuit and the basic processing circuit may be arbitrary and not limited to the H-type structure in FIG. 4. Alternatively, the structure from the primary processing circuit to the basic processing circuit is a broadcast or distribution structure, and the structure from the basic processing circuit to the primary processing circuit is a gather structure. Broadcast, distribution and collection are defined as follows: distribution or broadcast structures refers to that the number of basic processing circuits is greater than that of primary processing circuits, that is, one primary processing circuit corresponds to a plurality of basic processing circuits, that is, the structure from a primary processing circuit to a plurality of basic processing circuits is a broadcast or distribution structure. On the contrary, the structure from a plurality of basic processing circuits to the primary processing circuit may be a gather structure.

The basic processing circuit receives data distributed or broadcasted by the primary processing circuit and stores the data in the on-chip cache of the basic processing circuit. A result query operation may be performed by the basic processing circuit to obtain output results and the basic processing circuit may transmit data to the primary processing circuit.

Referring to the structure shown in FIG. 4, the structure includes a primary processing circuit and a plurality of basic processing circuits. The advantage of the combination is that the device may not only use the basic processing circuits to perform result query operation, but also use the primary processing circuit to perform other arbitrary result query operations, so that the device may complete more result query operations faster under the limited hardware circuit configuration. The combination reduces the number of data transmission with the outside of the device, improves computation efficiency and reduces power consumption. In addition, the chip may arrange the input data quantization circuit and the weight group data quantization circuit in both basic processing circuits and/or primary processing circuit, so that the input data and weight group data may be quantized in neural network computation. The chip may also dynamically distribute which circuit to perform quantization operation according to the amount of operation (load amount) of each circuit (mainly the primary processing circuit and the basic processing circuit), which may reduce complex procedures of data computation and reduce power consumption. and dynamic distribution of data quantization may not affect computation efficiency of the chip. The allocation method includes but is not limited to: load balancing, load minimum allocation and the like.

A neural network operation device is further provided in an embodiment of the present disclosure. The device includes one or more chips shown in FIG. 4 for acquiring data to be operated and control information from other processing devices, performing specified neural network operations, and transmitting execution results to peripheral devices through I/O interfaces. The peripherals may include cameras, monitors, mice, keyboards, network cards, WIFI interfaces, servers, and the like. When at least one chip shown in FIG. 4 is included, the integrated circuit chip device may link and transfer data with each other through a specific structure, for example, interconnecting and transmitting data over the PCIE bus to support larger scale neural network operations. In this case, the multiple operation devices may share the same control system, or have separate control systems. Further, the multiple operation devices may share the same memory, or each accelerator may have its own memory. In addition, the interconnection method may be any interconnection topology.

The neural network operation device has high compatibility and may be connected with various types of servers through the PCIE interface.

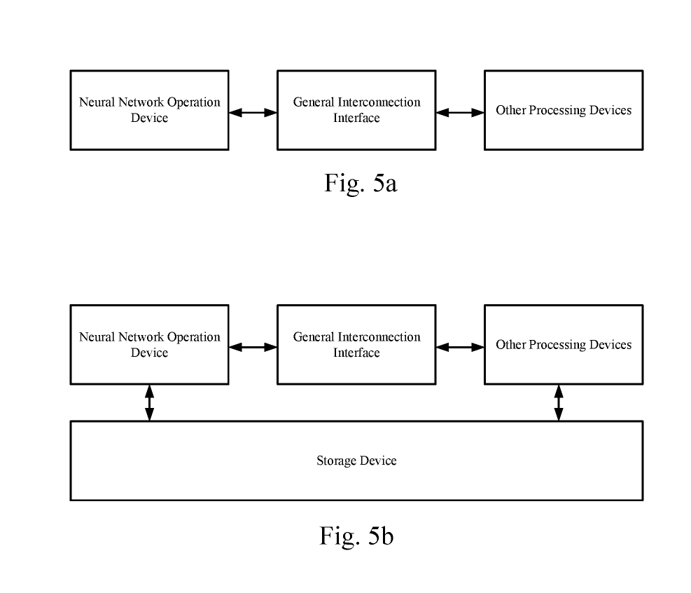

FIG. 5a is a structural diagram of a combined processing device according to an embodiment of the present disclosure. The combined processing device in the embodiment includes the neural network operation device, a general interconnection interface, and other processing devices (general processing devices). The neural network operation device interacts with other processing devices to perform the operations specified by users.

The other processing devices include at least one of general purpose/dedicated processors such as a central processing unit (CPU), a graphics processing unit (GPU), a neural network processor and the like. The number of processors included in other processing devices is not limited. The other processing devices serve as an interface connecting the neural network operation device with external data and control, include data moving, and perform the basic control of start and stop operations of the neural network operation device. The other processing devices may also cooperate with the neural network operation device to complete operation tasks.

The general interconnection interface is configured to transmit data and control instructions between the neural network operation device and the other processing devices. The neural network operation device may obtain the input data needed from the other processing devices and writes into on-chip storage devices of the neural network operation device. The neural network operation device may obtain control instructions from the other processing devices, and writes into on-chip control caches of the neural network operation device. The neural network operation device may also read data in the storage module of the neural network operation device and transmit the data to the other processing devices.

FIG. 5b is a structure diagram of another combined processing device according to an embodiment of the present disclosure. The combined storage device further includes a storage device and is configured to store the data needed in the operation unit/device or the other processing units, and is particularly suitable for storing the data which is needed to be operated and cannot be completely stored in the internal storage of the neural network operation device or the other processing devices.

The combined processing device can be used as an SOC on-chip system of devices such as a mobile phone, a robot, a drone, a video monitoring device, etc., thereby effectively reducing the core area of control parts, increasing the processing speed, and reducing the overall power consumption. In this case, the universal interconnection interfaces of the combined processing device are coupled with certain components of the device. The components include cameras, monitors, mice, keyboards, network cards, and WIFI interfaces.

In an alternative embodiment, the disclosure provides a chip, which includes the neural network operation device or the combined processing device.

In an alternative embodiment, the disclosure provides a chip package structure, which includes the chip.

In an alternative embodiment, the disclosure provides a board card, which includes the chip package structure.

In an alternative embodiment, the disclosure provides an electronic device, which includes the board card.

In an alternative embodiment, the disclosure provides an electronic device, which includes a robot, a computer, a printer, a scanner, a tablet computer, an intelligent terminal, a mobile phone, a drive recorder, a navigator, a sensor, a webcam, a cloud server, a camera, a video camera, a projector, a watch, an earphone, a mobile storage, a wearable device, a transportation means, a household electrical appliance, and/or a medical device.

The transportation means includes an airplane, a ship, and/or a vehicle. The household electrical appliance includes a television, an air conditioner, a microwave oven, a refrigerator, an electric rice cooker, a humidifier, a washing machine, an electric lamp, a gas cooker, and a range hood. The medical device includes a nuclear magnetic resonance spectrometer, a B-ultrasonic scanner, and/or an electrocardiograph.

In addition, functional units in various embodiments of the present disclosure may be integrated into one processing unit, or each unit may be physically present, or two or more units may be integrated into one unit. The integrated unit may be implemented in the form of hardware or a software function unit.

The integrated unit may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product which is stored in a memory and includes instructions making a computer device (which may be a personal computer, a server, or a network device and the like) perform all or part of the steps described in the various embodiments of the present disclosure. The memory includes various medium capable of storing program codes, such as a USB (universal serial bus) flash disk, a read-only memory (ROM), a random access memory (RAM), a removable hard disk, Disk, compact disc (CD) or the like.

Each functional unit/module in the disclosure may be hardware. For example, the hardware may be a circuit, including a digital circuit, an analogue circuit and the like. Physical implementation of a hardware structure includes, but is not limited to, a physical device, and the physical device includes, but is not limited to, a transistor, a memristor and the like. The computation module in the computation device may be any proper hardware processor, for example, a CPU, a graphics processing unit (GPU), a field-programmable gate array (FPGA), a digital signal processor (DSP), and an application specific integrated circuit (ASIC). The storage unit may be any proper magnetic storage medium or magneto-optical storage medium, for example, a resistance random access memory (RRAM), a DRAM, an SRAM, an embedded DRAM (EDRAM), a high bandwidth memory (HBM), and a hybrid memory cube (HMC).

Purposes, technical solutions and beneficial effects of the disclosure are further described above with the specific embodiments in detail. It should be understood that the above is only the specific embodiment of the disclosure and not intended to limit the disclosure. Any modifications, equivalent replacements, improvements and the like made within the spirit and principle of the disclosure shall fall within the scope of protection of the disclosure.

What is claimed is:

1. An integrated circuit chip device for training neural network, the neural network comprising n layers and n being an integer greater than 1, wherein the integrated circuit chip device comprises:
an external interface, configured to receive training instructions;
a processing circuit, configured to determine a first layer input data, a first layer weight group data and operation instructions included in the first layer of the training instructions, quantize the first layer input data and the first layer weight group data to obtain a first layer quantized input data and a first layer quantized weight group data; query a first layer output data corresponding to the first layer quantized input data and the first layer quantized weight group data from a preset output result table, determine the first layer output data as a second layer input data, and input the second layer input data into n−1 layers to execute forward operations to obtain n^{th} layer output data;
the processing circuit, further configured to determine n^{th} layer output data gradients of the n^{th} layer output data, obtain n^{th} layer back operations among the back operations of n layers of the training instructions, quantize the n^{th} layer output data gradients to obtain n^{th} layer quantized output data gradients, query n^{th} layer input data gradients corresponding to the n^{th} layer quantized output data gradients and a n^{th} layer quantized input data from the preset output result table, query n^{th} layer weight group gradients corresponding to the n^{th} layer quantized output data gradients and a n^{th} layer quantized weight group data from the preset output result table, and update a weight group data of n layers of the n^{th} layer weight group gradients;
the processing circuit, further configured to determine the n^{th} input data gradients as n−1^{th} output data gradients, and input the n^{th} input data gradients into n−1 layers to execute back operations to obtain n−1 weight group data gradients, and update n−1 weight group data corresponding to the n−1 weight group data gradients of the n−1 weight group data gradients, wherein the weight group data of each layer comprises at least two weights.

2. The device of claim 1, wherein for quantizing the first layer weight group data, the processing circuit comprises:
a control unit, configured to obtain quantization instructions and decode the quantization instructions to obtain query control information, the query control information comprising address information corresponding to the first layer weight group data in a preset weight dictionary, the preset weight dictionary comprising encodings corresponding to all the weights in weight group data of n layers of the neural network;
a dictionary query unit, configured to query K encodings corresponding to K weights in the first layer weight group data from the preset weight dictionary of the query control information, K being an integer greater than 1;
a codebook query unit, configured to query K quantized weights in the first layer quantized weight group data from the preset codebook of the K encodings, the preset codebook comprising Q encodings and Q central weights corresponding to the Q encodings, and Q is an integer greater than 1.

3. The device of claim 2, wherein the integrated circuit chip device further comprises a weight dictionary establishment unit, configured to:
determine closest central weights of each weight in the weight group data of n layers of the neural network to the Q central weights in the preset codebook, prior to quantizing the first layer weight group data, and obtain the central weights corresponding to each weight in weight group data of n layers;
determine encodings of the central weights corresponding to each weight in the weight group data of n layers of the preset codebook, obtain the encoding corresponding to each weight in the weight group data of n layers of the neural network and generate a weight dictionary.

4. The device of claim 2 or claim 3, wherein the processing unit is configured to perform the following steps to obtain the preset codebook:
grouping a plurality of weights to obtain a plurality of groups;
clustering weights in each group in the plurality of groups of a clustering algorithm to obtain a plurality of clusters;
computing a central weight of each cluster in the plurality of clusters;
encoding the central weight of each cluster in the plurality of clusters and generating the codebook.

5. The device of claim 4, wherein the clustering algorithm comprises any of the following algorithms:
K-means algorithm, K-medoids algorithm, Clara algorithm and Clarans algorithm.

6. The device of claim 5, wherein the neural network comprises a convolution layers, b full connection layers and c long short-term memory network layers, and the grouping a plurality of weights to obtain a plurality of groups comprises:
grouping weights in each convolution layer of the plurality of weights into a group, weights in each full connection layer of the plurality of weights into a group and weights in each long short-term memory network layer of the plurality of weights into a group to obtain (a+b+c) groups;
the clustering weights in each group in the plurality of groups of a clustering algorithm comprises:
clustering weights in each of the (a+b+c) groups of the K-medoids algorithm.

7. The device of any of claim 1 to claim 6, wherein for quantizing the first layer input data, the processing circuit further comprises:
a preprocessing unit, configured to preprocess any element value in the first layer input data using a clip (−zone, zone) operation to obtain the first layer preprocessing data in the preset section [−zone, zone], zone being greater than 0;
a determination unit, configured to determine M values in the preset section [−zone, zone], M being a positive integer, compute absolute values of differences between the first layer preprocessing data and the M values respectively to obtain M absolute values, and determine a minimum absolute value of the M absolute values as the quantized element value corresponding to the element value.

8. A neural network training method for executing neural network training, the neural network comprising n layers with n being an integer greater than 1, wherein the neural network training method comprises:
receiving training instructions;
determining a first layer input data, a first layer weight group data and the operation instructions included in the first layer of the training instructions; quantizing the first layer input data and the first layer weight group data to obtain the first layer quantized input data and the first layer quantized weight group data;
querying a first layer output data corresponding to the first layer quantized input data and the first layer quantized weight group data from the preset output result table, determining the first layer output data as the second layer input data and inputting the second layer input data into n−1 layers to execute forward operations to obtain the n^{th} layer output data;
determining n^{th} layer output data gradients of the n^{th} layer output data, obtaining the n^{th} layer back operations among back operations of n layers of the training instructions, quantizing the n^{th} layer output data gradients to obtain n^{th} layer quantized output data gradients;
querying n^{th} layer input data gradients corresponding to the n^{th} layer quantized output data gradients and a n^{th} layer quantized input data from the preset output result table, querying n^{th} layer weight group gradients corresponding to the n^{th} layer quantized output data gradients and a n^{th} layer quantized weight group data from the preset output result table, and updating the weight group data of n layers of the n^{th} layer weight group gradients;
determining the n^{th} input data gradients as the n−1^{th} output data gradients, inputting the n−1th output data gradients into n−1 layers to execute back operations to obtain the n−1 weight group data gradients, updating the n−1 weight group data corresponding to the n−1 weight group data gradients of the n−1 weight group data gradients, wherein the weight group data of each layer comprises at least two weights.

9. The method of claim 8, wherein the quantizing the first layer weight group data comprises:
obtaining quantization instructions and decoding the quantization instructions to obtain query control information, the query control information comprising address information corresponding to the first layer weight group data in a preset weight dictionary and the preset weight dictionary including encodings corresponding to all the weights in the weight group data of n layers of the neural network;
querying K encodings corresponding to K weights in the first layer weight group data from the preset weight dictionary of the query control information, K being an integer greater than 1;
querying K quantized weights in the first layer quantized weight group data from the preset codebook of the K encodings, the preset codebook including Q encodings and Q central weights corresponding to the Q encodings, and Q is an integer greater than 1.

10. The method of claim 9, wherein the preset weight dictionary is obtained according to the following steps:
determining the closest central weights of each weight in the weight group data of n layers of the neural network to the Q central weights in the preset codebook, prior to quantizing the first layer weight group data, and obtaining the central weights corresponding to each weight in the weight group data of n layers;
determining encodings of the central weights corresponding to each weight in the weight group data of n layers of the preset codebook, obtaining the encoding corresponding to each weight in the weight group data of n layers of the neural network and generating a weight dictionary.

11. The method of claim 9 or claim 10, wherein the preset codebook is obtained according to the following steps:
grouping a plurality of weights to obtain a plurality of groups;
clustering weights in each group in the plurality of groups of the clustering algorithm to obtain a plurality of clusters;
computing the central weight of each cluster in the plurality of clusters;
encoding the central weight of each cluster in the plurality of clusters and generating the codebook.

12. The method of claim 11, wherein the clustering algorithm comprises any of the following algorithms:
K-means algorithm, K-medoids algorithm, Clara algorithm and Clarans algorithm.

13. The method of claim 12, wherein the neural network comprises a convolution layers, b full connection layers and c long short-term memory network layers, and the grouping a plurality of weights to obtain a plurality of groups comprises:
grouping weights in each convolution layer of the plurality of weights into a group, weights in each full connection layer of the plurality of weights into a group and weights in each long short-term memory network layer of the plurality of weights into a group to obtain (a+b+c) groups;
the clustering weights in each group in the plurality of groups of a clustering algorithm comprises:
clustering weights in each of the (a+b+c) groups of the K-medoids algorithm.

14. The method of any of claim 8 to claim 13, wherein the quantizing the first layer input data comprises:
preprocessing any element value in the first layer input data using a clip (−zone, zone) operation to obtain the first layer preprocessing data in the preset section [−zone, zone], zone being greater than 0;
determining M values in the preset section [−zone, zone], M being a positive integer, computing absolute values of differences between the first layer preprocessing data and the M values respectively to obtain M absolute values, and determining the minimum absolute value of the M absolute values as the quantized element value corresponding to the element value.

15. A neural network operation device, wherein the neural network operation device comprises at least one integrated circuit chip device of any of claim 1 to claim 7.

16. A chip, wherein the chip is configured to integrate the device of any of claim 1 to claim 7.

17. An electronic device, wherein the electronic device comprises the chip of claim 16.
